(19) United States
(12) Patent Application Publication
(10) Pub. No.: US 2015/0358318 A1
(43) Pub. Date: Dec. 10, 2015

(54) BIOMETRIC AUTHENTICATION OF CONTENT FOR SOCIAL NETWORKS

(71) Applicant: Mary A Spio, Miami Beach, FL (US)

(72) Inventor: Mary A Spio, Miami Beach, FL (US)

(21) Appl. No.: 14/733,459

(22) Filed: Jun. 8, 2015

Related U.S. Application Data
(60) Provisional application No. 62/009,091, filed on Jun. 6, 2014.

(51) Int. Cl. H04L 29/06; G06F 21/34; H04L 29/08; G06F 21/32

(52) U.S. Cl. CPC H04L 63/0861; H04L 63/0853; G06F 21/32; G06F 21/34; H04L 67/02

(57) ABSTRACT

A method on a web server for biometric authentication of content for social networks including providing a user interface configured for accepting login data and proposed content captured from a remote computing device of a user and authenticating said user by comparing the login data entered into the user interface and login data in a user record corresponding to said user. The method further includes determining whether the proposed content is authentic by searching for a biometric cue in the proposed content and if the proposed content includes a biometric cue, then: a) generating approved content comprising at least a portion of the proposed content and an authentication mark, and b) transmitting, over the communication network, the approved content.

### CROSS-REFERENCE TO RELATED APPLICATIONS

This patent application claims priority to provisional application No. 61/009,091 filed Jun. 6, 2014. The subject matter of provisional application No. 61/009,091 is hereby incorporated by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The present invention relates to the field of social networks, and more specifically to the field of authentication for social networks.

### BACKGROUND

In today's social and crowd-sourced economy we depend on virtual strangers for everything. From car rides, to renting space in our homes where both host and guest are susceptible to danger, caring for loved ones, finding love, or finding people to attend events and activities, we as a society depend on virtual strangers. At the same time, deception online is at an all-time high, thanks to lack of verification of the content placed online

A report from Cornell University entitled “The Truth about Lying in Online Dating Profile” revealed that deception was observed in approximately Eight out of Ten (81%) of the participants' profile variables. Online users often use old pictures, manipulated pictures or images of others to gain some sort of leverage. These practices cause a great deal of time wasting on the benign end of the spectrum, to highly risky and dangerous activities at the other end of the spectrum. Numerous news agencies have reported stories on fake photos being used to entice online users into meeting or conducting business only to be duped.

For example, say a first person finds and pays an amount of money for a week at a bed and breakfast in New York through an online add. The online ad has photographs that appear real but are unverified. The first user then goes on vacation and arrives at the address of the bed and breakfast only to find that the bed and breakfast does not exist. The bed and breakfast was not real and the first user was defrauded by an individual who uploaded to the internet fake photographs and other content. Because of the unverified photos and other content, the first user is now inconvenienced and has additional expense of having to scramble for a hotel at the last minute.

In order to scam the first person, the bed and breakfast must upload fake photos online Currently, such images and content are not traceable and the social networks and websites where these photos and content have been posted currently have no scalable and easy way of verifying these posts. Currently, in order to verify online content, individuals often ask others to hold an updated newspaper and to take photos to show proof of being recent or that the person taking the picture was actually at the location where the photograph or other content was taken. However such means of verifying proof of content is cumbersome, time-consuming and inconvenient.

Other solutions of proving the veracity of photographs and content require a business to send out photographers to physically verify the information and document the information with photographs and other audio visual (A/V) means.

As a result, there exists a need for improvements over the prior art and more particularly for a more efficient way of verifying the veracity of online content.

### SUMMARY

A method on a web server for biometric authentication of content for social networks is disclosed. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a method on a web server for biometric authentication of content for social networks is disclosed. The method includes 1) providing, over a communications network, a first user interface configured for accepting login data comprising an email address and authentication code; 2) storing in an attached database a user record including said login data; 3) providing, over the communications network, a second user interface configured for accepting login data and proposed content captured from a remote computing device of said user; 4) authenticating said user by comparing the login data entered into the second user interface to the login data in the user record corresponding to said user; 5) determining whether the proposed content is authentic by searching for a biometric cue in the proposed content; if the proposed content includes a biometric cue, then: a) generating approved content comprising at least a portion of the proposed content and an authentication mark, and b) transmitting, over the communication network, to the second user interface, a message including the approved content and an approval; and if the proposed content does not include a biometric cue, then transmitting, over the communication network, to the second user interface, a message including a denial of the proposed content.

Additional aspects of the disclosed embodiment will be set forth in part in the description which follows, and in part will be obvious from the description, or may be learned by practice of the disclosed embodiments. The aspects of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute part of this specification, illustrate embodiments of the invention and together with the description, serve to explain the principles of the disclosed embodiments. The embodiments illustrated herein are presently preferred, it being understood, however, that the invention is not limited to the precise arrangements and instrumentalities shown, wherein:

FIG. 1 is a diagram of an operating environment that supports a method on a web server for biometric authentication of content for social networks, according to an example embodiment;

FIG. 2A is a diagram showing the data flow of the method on a web server for biometric authentication of content for social networks, according to an example embodiment;

FIG. 2B is a diagram showing a further data flow of the method on a web server for biometric authentication of content for social networks, according to another example embodiment;

FIG. 3A is a flow chart depicting the general control flow of the method on a web server for biometric authentication of content for social networks, according to an example embodiment;

FIG. 3B is a flow chart depicting the general control flow of the method on a web server for biometric authentication of content for social networks, according to an example embodiment; and,

FIG. 4 is a block diagram of a system including an example computing device and other computing devices.

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions or modifications may be made to the elements illustrated in the drawings, and the methods described herein may be modified by substituting reordering, or adding additional stages or components to the disclosed methods and devices. Accordingly, the following detailed description does not limit the disclosed embodiments. Instead, the proper scope of the disclosed embodiments is defined by the appended claims.

The disclosed embodiments improve upon the problems with the prior art by allowing consumers to use any image or video capturing device supported by the system to capture content that can be easily verified by the system. The disclosed system improves over the prior art by using biometric cues to identify whether proposed content is authentic, and consequently marking said authenticated content. The system also improves over the prior art by using the presence of a mark on an image or video or other content to verify that content has been authenticated or approved. The system will improve over the prior art by reducing the amount of time and money wasted in order to verify that online content is authentic. Additionally, the system will improve over the prior art by using geo-fencing and geo-tracking technology to verify the geographic location of where the image or other proposed content was captured in order to further authenticate the veracity of the proposed content.

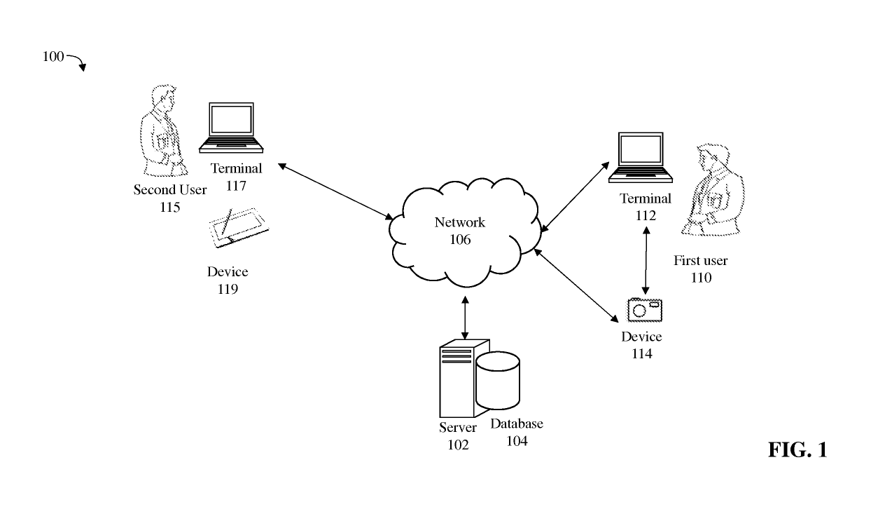

Referring now to the Figures, FIG. 1 is a diagram of an operating environment that supports a method on a web server for biometric authentication of content for social networks, according to an example embodiment. A prominent element of FIG. 1 is the server 102 associated with repository or database 104 and further coupled with network 106, which can be a circuit switched network, such as the Public Service Telephone Network (PSTN), or a packet switched network, such as the Internet or the World Wide Web, the global telephone network, a cellular network, a mobile communications network, or any combination of the above. Server 102 is a central controller or operator for functionality of the disclosed embodiments, namely, the method for biometric authentication of content for social networks.

FIG. 1 includes remote computing devices such as terminals 112, 117 and devices 117, 119, which may be smart phones, mobile phones, tablet computers, handheld computers, laptops, cameras, video cameras or the like. Terminal 112 and device 114 correspond to a user 110. Terminal 117 and device 119 correspond to a second user 115. Terminal 112 and device 112 have the capability of capturing content such as audio and visual and such devices and terminals may also comprise a camera, video camera, camcorder, camera phone, compact camera, dashcam, digital camera, disposable camera, document camera, high-speed camera, light-field camera, movie camera, etc, red light camera etc. Terminal 112 and device 114 may also comprise the capability to capture and provide the date and time that content was captured. Additionally, terminal 112 and device 114 may also comprise a global positioning system (GPS) such that terminal 112 and device 114 have the capability to include the geographic location (latitude, longitude and altitude) of location of where the content was captured.

FIG. 1 further shows that server 102 includes a database or repository 104, which may be a relational database comprising a Structured Query Language (SQL) database stored in a SQL server. Terminals 112, 117 and devices 114 and 119 may also each include their own database. The repository 104 serves data from a database, which is a repository for data used by server 102 and terminals 112, 117 and devices 114 and 119 during the course of operation of the disclosed embodiments. Database 104 may be distributed over one or more nodes or locations that are connected via network 106.

The database may also include a user record for each user 110 or 115. A user record may include: login data for the user (see below), contact/identifying information for the user (name, address, telephone number(s), email address, etc.); an IP address for each device of the user; and an authentication code. A user record may further include: a unique identifier for each user, a residential address for each user, the current location of each user (based on location-based services from the user's mobile computer) and a description of past content uploaded by each user. A user record may further include demographic data for each user, such as age, sex, income data, race, color, marital status, etc. Each user record may also include proposed content or approved content (further explained below) for each user.

The server 102 may be configured for providing, over the communications network, a first user interface on terminal 114, device 114 that is configured for accepting login data comprising an email address and authentication code. The login data may also include a name, address, telephone number(s), etc. The server can also be configured for storing in an attached database a user record including said login data for a plurality of users.

The server is also configured for providing, over the communications network, a second user interface configured for accepting login data and proposed content captured from terminal 112 or device 114. The server can also be configured to authenticate the proposed by comparing the login data entered into the second user interface to the login data in the user record corresponding to said user. Additionally, the server can be configured for providing a third user interface configured for accepting login data comprising an email address and authentication code from terminal 117 or device 119 from a second user 115. The server can also be configured for storing in an attached database a second user record including said second user login data. The server is also configured for providing a fourth user interface configured for accepting login data of said second user and authenticating said second user by comparing the login data entered into the fourth user interface to the login data in the second user record corresponding to said second user. The server may also be configured for providing over the communications network, a fifth user interface configured for displaying approved content.

The captured proposed content may include audio and visual content. The audio and visual content may include data having a sound and/or visual component or any combination thereof. The audio and visual content may comprise biometric cues. The biometric cues may refer to audio and visual data that only exists if at least a portion of the audio and visual content was physically present when the content was captured. Such biometric cues include light points, facial gestures, motion of subjects and motion of background objects, blinks of a person, voice recognition, eye tracking, lip movement, sounds, retina scans, and fingerprint of the proposed content. However, other biometric cues may be used and are within the spirit and scope of the invention.

The audio and visual content may also include date and time data identifiers, which reflect the date and time of when the proposed content was captured by device 114 and terminal 112. The audio and visual content may also include data, such as the GPS data (longitude, latitude and altitude data) relating to where the proposed content was captured.

The server is also configured to determine whether the proposed content is authentic by searching for a biometric cue in the proposed content. The server may include software which does analysis of the content and uses algorithms to detect light points, measure facial gestures, measure or detect motion—such as the difference between the motion in background and the subject of interest—measure blink rates of a person, voice recognition, eye tracking and lip movement of the proposed content. The biometric cues may be used to determine if a subject captured by a remote computing device was present when the proposed content was captured. If a biometric use is present, then the proposed content may be valid or authentic. For example, by measuring the motion of the main subject compared to the motion in the background the server may be able to determine if the proposed content is authentic or that the subject was present when the proposed content was captured. Additionally, using algorithms to detect facial expression such as smile, frown rate etc. may be used to detect biometric cues to determine if the subject of the proposed subject was physically present when the content was taken. Additionally, other biometric cues may include the date and time data on the proposed content. The server may also use the date and time to determine how recent audio and visual content was captured to determine if the authentic based upon what the user has claimed the proposed content to be. The server may also be configured to use the biometric cues of the GPS location of where the proposed content was captured to determine if the proposed content is authentic based upon where the user claims the proposed content is alleged to be physically located.

The server can also be configured to generate approved content comprising at least a portion of the proposed content and an authentication mark if the proposed content includes a biometric cue. The approved content may include audio and visual content. The audio and visual content of the approved content may also include data having a sound and/or visual component or any combination thereof. The audio and visual content of the approved content may also include date and time data identifiers, which reflect the date and time of when the proposed content was captured by devices 114 and terminal 112. The audio and visual content of the approved content may also include data, such as the GPS data (longitude, latitude and altitude) relating to where the approved content was captured.

The authentication mark may be any identifying mark, such as a watermark, which may be an identifying image or pattern or packet of data that appears on the approved content when viewed by user, a unique alphanumeric value, a matrix barcode, a linear barcode or a unique image or any combination thereof. The authentication mark may also include date and time data identifiers, which reflect the date and time of when the proposed content was captured. Then authentication mark may also include GPS identifies, which includes the GPS data (longitude, latitude, and/or altitude) of where the approved data captured. Additionally, other means of providing an authentication mark on the approved content and such other marks are within the spirit and scope of the present invention.

The server can also be configured for transmitting, over the communication network, to the second user interface for display on terminal 112 or devices 114, a message including the approved content and an approval if the server determines the proposed content includes a biometric cue and/or is valid. Additionally, the server may also be configured for storing each user record the approved content of each user in the attached database 104.

Additionally the server may also be configured for transmitting, over the communication network, to the second user interface, a message including a denial of the proposed content if the proposed content does not include a biometric cue and/or is not valid or authentic. Each of the messages may be sent via a network protocol, such as HTTP.

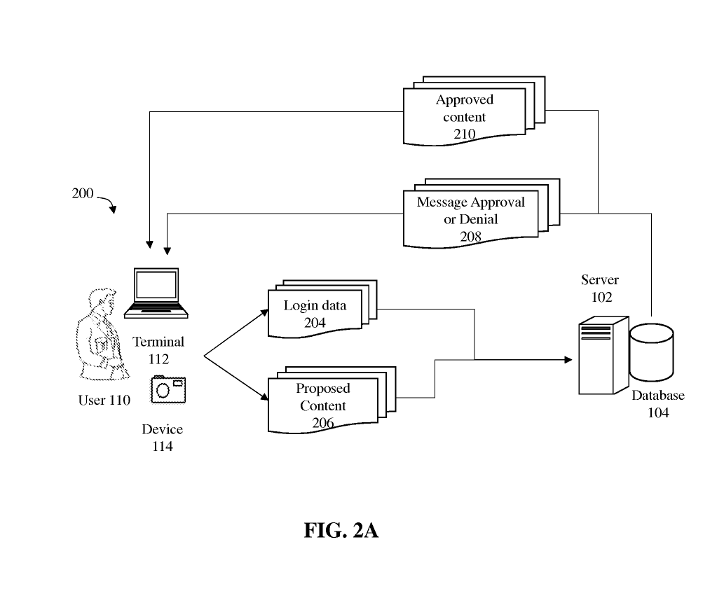

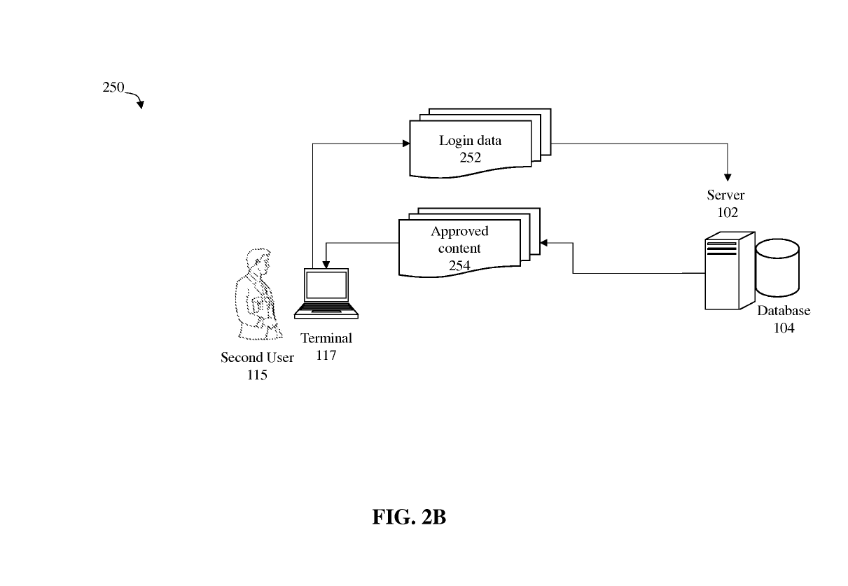

FIG. 2A is a diagram illustrating the data flow 200 of the method on a web server for biometric authentication of content for social networks, according to an example embodiment. FIG. 2A illustrates that the first user can provide to the server login data 204, which includes an email address and authentication code, into the first user interface provided by the server. A user may also use the remote computing device 114, 112, such as a camera etc., to capture proposed content comprising content such as audio and visual content, which is accepted by the second user interface provided by the server. If the login data entered by the user matches the login data that is stored in association with a user record corresponding to the user, then the user is authenticated by the server and the process continues.

The content may also contain biometric cues such as those mentioned above. Next, the login data 204 and proposed content is accepted by the server. Next, the server can analyze the proposed content to determine if the proposed content 206 received is authentic by searching for a biometric cue in the proposed content. Next, if the proposed 206 content includes a biometric cue, the system can generate approved content 210 comprising at least a portion of the proposed content and an authentication mark and transmit to the second user interface the approved content for display on the remote computing device 112, 114. Additionally, the sever may also transmit, over the communication network, to the second user interface, a message including a message of approval 208 indicating that the content has been approved. If the proposed content does not include a biometric cue, then the server 102 can transmit, over the communication network, to the second user interface, a message 208 including a denial of the proposed content. The messages may be transmitted to and from the server via a network protocol, such as HTTP.

FIG. 2B is a diagram illustrating the data flow 250 of the method on a web server for distributing approved content to users of social networks, according to an example embodiment. FIG. 2B illustrates how a second user 115 can view approved content of other users. The second user will enter login data 252 comprising at least an email address and authenticate code of the second user into a user interface provided by the server, over the communications network, and configured for accepting the login data. The login data may also include a name, address, telephone number(s), etc. The login data is then received by server 102 and stored in an attached database 104 in a user record corresponding to the user. Next, the second user may enter login data into a user interface provided by the server and if the server authenticates the second user by comparing the login data entered into the user interface provided by the server, then the server can provide to the terminal 117 or device 114 a user interface configured for displaying approved content 254 of other users. The second user may view the approved content having the authentication mark knowing that such content has been authenticated by the system. The second user may use the approved content to decrease the amount of time to verify the veracity of the content that the user is viewing on social networks.

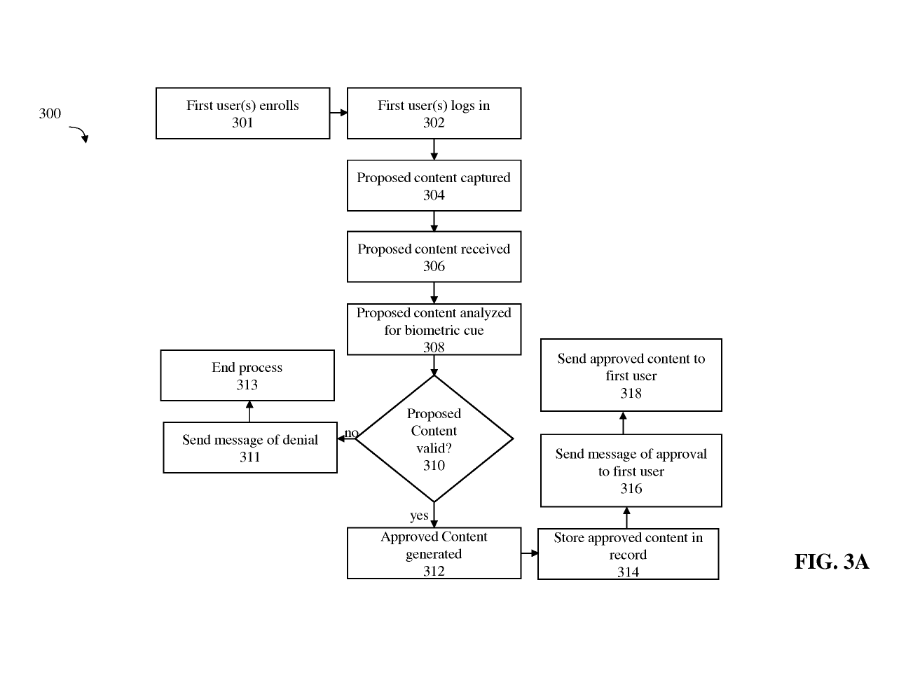

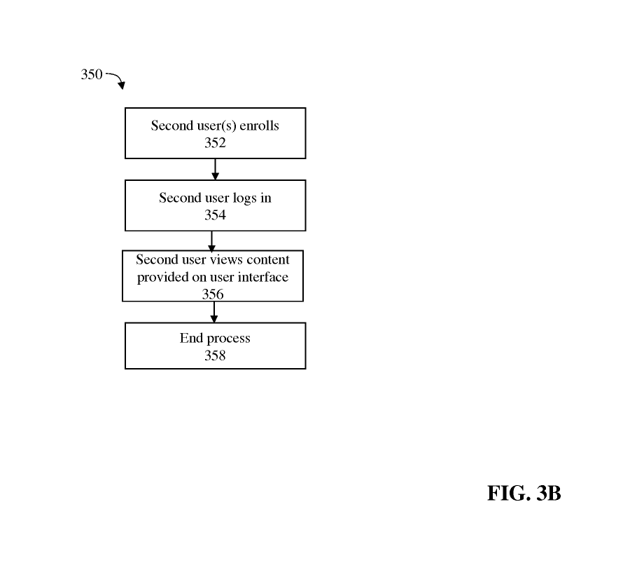

FIG. 3A is a flow chart depicting the general control flow 300 of the method on a web server for biometric authentication of users for social networks, according to an example embodiment. In step 301, the first user 110 enrolls by providing login data comprising an email address and authentication code into a first user interface provided by server 102. The server stores the login data in an attached database in a user record. Next, in step 302, the first user enters login data into a second user interface provided by the server, over the communications network, which such second user interface is configured for accepting login data. The server then authenticates the first user by comparing the login data entered into the second user interface to the login data in the user record corresponding to the first user. Next, in step 304 the proposed content can be captured by capturing device of the terminal 112, device 114. As mentioned above, the proposed content any audio and visual content. The proposed content may include biometric cues as explained above. Next, in step 306, the proposed content received by the second user interface is transmitted and received by the server. In one embodiment, the capturing device may be triggered by specific biometric cues detected.

Next in step 308, the proposed content is analyzed for biometric cues to determine if the proposed content is authentic or valid. As mentioned above, the server may include software which does analysis and uses software to detect light points, measure facial gestures, measure motion—such as the difference between the motion in background and the subject of interest—measure blink rates, voice recognition, eye tracking and lip movement of the proposed content. The server performs the analysis and uses the software to determine if biometric cues were present and if a subject of the proposed content was physically present when the proposed content was captured. Additionally, the analysis may also include comparing the GPS location of where the proposed content was alleged to have been captured to the actual GPS location provided by the capturing device. Additionally, algorithms or software may also be included to determine if the proposed content is authentic by comparing the date and time of when the content was alleged to have been captured to the date and time stamp or identifier provided by the capturing device.

In step 310, if it is determined that the proposed content does not include a biometric cue or is otherwise valid or authentic, then the process moves to step 311. In step 311, after it has been determined that the proposed content does not include a biometric cue or is otherwise invalid and/or is not authentic, then the server transmits, over the communications network, to the second user interface provided on terminal 112 or device 114 a message indicating a denial of the proposed content. Next, the process moves to step 313 and the process flow ends.

If in step 310 it is determined that the proposed content does include a biometric cue or is otherwise valid and/or authentic, then the process moves to step 312. In step 312, the server generates the approved content. The approved content comprises at least a portion of the proposed content and an authentication mark. As mentioned above the authentication mark may include any identifying mark, such as a watermark, a unique alphanumeric value, a matrix barcode, a linear barcode or a unique image.

Next, process moves to step 314. In step 314, the approved content may be stored in the attached database 104 corresponding to the user record. Next, the process may move to step 316. In step 316, a message of approval of the proposed content may be transmitted, over the communications network, to the second user interface and displayed on terminal 112 or device 114 for review by the first user. Additionally, in step 318, a message including the approved content may be transmitted, over the communications network, to the second user interface and displayed on terminal 112 or device 114 for viewing by the first user. Such messages may be sent via HTTP. After receiving the approved content, first user may further disseminate or distribute the approved content to others on the social networks. By seeing the authentication mark of the approved content disseminated or distributed by the first user, others may conclude that the subject of the approved content was present at the time the photograph or audio visual content was captured. Additionally, the captured and approved content may also be used for verification against other documents.

FIG. 3B is a diagram illustrating the control flow 350 of the method on a web server for biometric authentication of content for social networks, according to another example embodiment. FIG. 3B illustrates that the approved content may be displayed to second users 115. In step 352, the second user enrolls. To do so, a third user interface may be provided, over the communications network. The third user interface is configured for accepting login data comprising an email address and authentication code of a second user. The login data may also include a name, address, telephone number(s), etc. The login data may be stored in the attached database 104 in a second user record. Next, in step 354, the second user may login. To do so, a fourth user interface may be provided, which is configured for accepting login data input by a second user. Next, the system authenticates the second user by comparing the login data entered into the fourth user interface to the login data in the second user record corresponding to said second user. After the user has logged in, next in step 356, the second user can view the approved content of at least one user that is displayed on a fifth user interface which is configured for displaying the approved content of at least one user. By seeing the authentication mark of the approved content, second users can conclude that the subject of the approved content was present at the time the photograph or audiovisual content was captured. Additionally, the captured and approved content may also be used for verification against other documents.

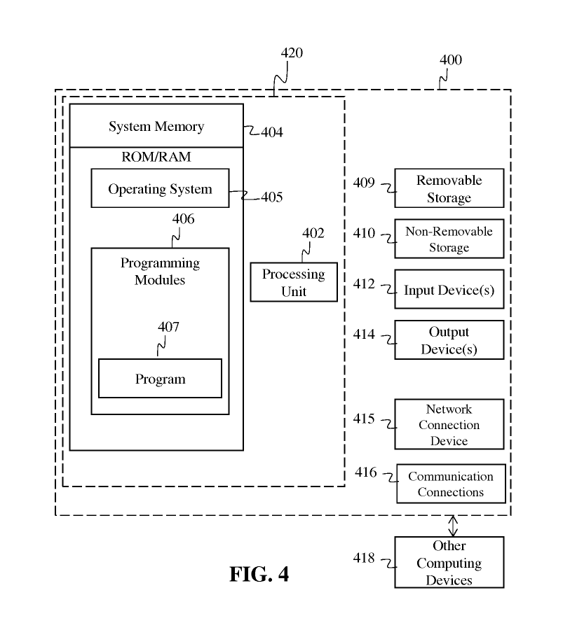

FIG. 4 is a block diagram of a system including an example computing device 400 and other computing devices. Consistent with the embodiments described herein, the aforementioned actions performed by server 102 may be implemented in a computing device, such as the computing device 400 of FIG. 4. Any suitable combination of hardware, software, or firmware may be used to implement the computing device 400. The aforementioned system, device, and processors are examples and other systems, devices, and processors may comprise the aforementioned computing device. Furthermore, computing device 400 may comprise an operating environment for the data flow and processes shown in FIGS. 2A-3B above.

With reference to FIG. 4, a system consistent with an embodiment of the invention may include a plurality of computing devices, such as computing device 400. In a basic configuration, computing device 400 may include at least one processing unit 402 and a system memory 404. Depending on the configuration and type of computing device, system memory 404 may comprise, but is not limited to, volatile (e.g. random access memory (RAM)), non-volatile (e.g. read-only memory (ROM)), flash memory, or any combination or memory. System memory 404 may include operating system 405, one or more programming modules 406 (such as program module 407). Operating system 405, for example, may be suitable for controlling computing device 400's operation. In one embodiment, programming modules 406 may include, for example, a program module 407. Furthermore, embodiments of the invention may be practiced in conjunction with a graphics library, other operating systems, or any other application program and is not limited to any particular application or system. This basic configuration is illustrated in FIG. 4 by those components within a dashed line 420.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a camera, a touch input device, etc. Output device(s) 414 such as a display, speakers, a printer, etc. may also be included. The aforementioned devices are only examples, and other devices may be added or substituted.

Computing device 400 may also contain a communication connection 416 that may allow device 400 to communicate with other computing devices 418, such as over a network in a distributed computing environment, for example, an intranet or the Internet. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

Device 415 may be a network connection device or network interface device (also known as a network interface card, network adapter, LAN adapter, and by similar terms), which is a computer hardware component that connects a computer to a computer network. The network interface device implements the electronic circuitry required to communicate using a specific physical layer and data link layer standard such as Ethernet, Wi-Fi or Token Ring. This provides a base for a full network protocol stack, allowing communication among small groups of computers on the same LAN and large-scale network communications through routable protocols, such as IP.

As stated above, a number of program modules and data files may be stored in system memory 404, including operating system 405. While executing on processing unit 402, programming modules 406 may perform processes including, for example, one or more of the methods, processes or data flow shown in FIGS. 2A-3B above. Computing device 402 may also include a graphics processing unit 403, which supplements the processing capabilities of processor 402 and which may execute programming modules 406, including all or a portion of those processes and methods shown in FIGS. 2A-3B above. The aforementioned processes are examples, and processing units 402, 403 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the invention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A method on a web server for biometric authentication of content for social networks, the method comprising:
providing, over a communications network communicatively coupled with the web server, a first user interface configured for accepting login data comprising an email address and authentication code;
storing in an attached database a user record including said login data;
providing, over the communications network, a second user interface configured for accepting login data and proposed content captured from a remote computing device of said user;
authenticating said user by comparing the login data entered into the second user interface to the login data in the user record corresponding to said user;
determining whether the proposed content is authentic by searching for a biometric cue in the proposed content;
if the proposed content includes a biometric cue, then: a) generating approved content comprising at least a portion of the proposed content and an authentication mark, and b) transmitting, over the communication network, to the second user interface, a message including the approved content and an approval;
if the proposed content does not include a biometric cue, then transmitting, over the communication network, to the second user interface, a message including a denial of the proposed content.

2. The method of claim 1, wherein the method further includes storing in each user record the approved content of each user.

3. The method of claim 1, wherein the proposed content comprises audio/visual content.

4. The method of claim 1, wherein the method is further configured for reading a date and time the proposed content was captured and, if the proposed content is approved, then the authentication mark further includes a date and time identifier of when the approved content was captured.

5. The method of claim 1, wherein the method is further configured for reading a geographical location of where the proposed content was captured and, if the proposed content is approved, then the authentication mark further includes a geographical location identifier of where the approved content was captured.

6. The method of claim 1, wherein the biometric cue includes one or more of motion data, fingerprint data light data, and facial data.

7. The method of claim 1, wherein the message with the approved content is sent via HTTP.

8. The method of claim 1, wherein the message indicating the denial of acceptance of the proposed content is sent via HTTP.

9. The method of claim 1, wherein the message displaying the message indicating the approval of the proposed content is sent via HTTP.

10. A method on a web server for biometric authentication of content for social networks, the method comprising:
providing, over a communications network communicatively coupled with the web server, a first user interface configured for accepting login data comprising an email address and authentication code;
storing in an attached database a user record including said login data;
providing, over the communications network, a second user interface configured for accepting login data and proposed content captured from a remote computing device of said user;
authenticating said user by comparing the login data entered into the second user interface to the login data in the user record corresponding to said user;
determining whether the proposed content is authentic by searching for a biometric cue in the proposed content;
if the proposed content includes a biometric cue, then: a) generating approved content comprising at least a portion of the proposed content and an authentication mark, and b) transmitting, over the communication network, to the second user interface, a message including the approved content and an approval;
if the proposed content does not include a biometric cue, then transmitting, over the communication network, to the second user interface, a message including a denial of the proposed content;
providing, over the communications network, a third user interface configured for accepting login data comprising an email address and authentication code of a second user;
storing in an attached database a second user record including said second user login data;
providing, over the communications network, a fourth user interface configured for accepting login data of said second user;
authenticating said second user by comparing the login data entered into the fourth user interface to the login data in the second user record corresponding to said second user; and,
providing, over the communications network, a fifth user interface configured for displaying approved content of at least one user.

11. The method of claim 10, wherein the method further includes storing in each user record the approved content of each user.

12. The method of claim 10, wherein the proposed content comprises audio/visual content.

13. The method of claim 10, wherein the method is further configured for reading a date and time the proposed content was captured and, if the proposed content is approved, then the authentication mark further includes a date and time identifier of when the approved content was captured.

14. The method of claim 10, wherein the method is further configured for reading a geographical location of where the proposed content was captured and, if the proposed content is approved, then the authentication mark further includes a geographical location identifier of where the approved content was captured.

15. The method of claim 10, wherein the biometric cue includes one or more of motion data, fingerprint data light data, and facial data.

16. The method of claim 10, wherein the message with the approved content is sent via HTTP.

17. The method of claim 10, wherein the message indicating the denial of acceptance of the proposed content is sent via HTTP.

18. The method of claim 10, wherein the message displaying the message indicating the approval of the proposed content is sent via HTTP.

19. A computer system for biometrically authenticating content for social networks comprising:
a database for storing a user record for each of a plurality of users, wherein each user record includes an email address and authentication code for each user;
a memory;
a network interface device communicatively coupled with a communications network; and,
a processor communicatively coupled with the database, the memory and the network interface device, the processor configured for:
providing, over the communications network, a first user interface configured for accepting login data comprising an email address and authentication code;
storing in an attached database a user record including said login data;
providing, over the communications network, a second user interface configured for accepting login data and proposed content captured from a remote computing device of said user;
authenticating said user by comparing the login data entered into the second user interface to the login data in the user record corresponding to said user;
determining whether the proposed content is authentic by searching for a biometric cue in the proposed content;
if the proposed content includes a biometric cue, then: a) generating approved content comprising at least a portion of the proposed content and an authentication mark, and b) transmitting, over the communication network, to the second user interface, a message including the approved content and an approval;
if the proposed content does not include a biometric cue, then transmitting, over the communication network, to the second user interface, a message including a denial of the proposed content;
providing, over the communications network, a third user interface configured for accepting login data comprising an email address and authentication code of a second user;
storing in an attached database a second user record including said second user login data;
providing, over the communications network, a fourth user interface configured for accepting login data of said second user;
authenticating said second user by comparing the login data entered into the fourth user interface to the login data in the user record corresponding to said second user; and,
providing, over the communications network, a fifth user interface configured for displaying approved content of at least one user.

20. The computer system of claim 19, wherein the process is further configured for storing in each user record the approved content of each user.
